(19) United States
(12) Patent Application Publication
(10) Pub. No.: US 2015/0203404 A1
(43) Pub. Date: Jul. 23, 2015

(54) Powder Mixture And Process To Make Dry Mortar

(71) Applicant: Akzo Nobel Chemicals International B.V., Amersfoort (NL)

(72) Inventor: Thomas Aberle, Nottwil (CH)

(21) Appl. No.: 14/410,187

(22) PCT Filed: Jul. 8, 2013
(86) PCT No.: PCT/EP2013/064336

§ 371 Date: Dec. 22, 2014

(30) Foreign Application Priority Data
Jul. 10, 2012 (EP) 12175671.2

(51) Int. Cl. C04B 24/10; C04B 24/42

(52) U.S. Cl. CPC C04B 24/10; C04B 24/42

(57) ABSTRACT

The present invention provides a powder mixture suitable for hydrophobizing and thickening cementitious mortars, comprising a) 5-90 wt % of one or more water-thickeners i), said thickener i) being in powder form and selected from a specific group, b) 5-90 wt % of one or more component ii), wherein component ii) is in powder form and comprises one or more components iia) selected from the group of fatty acids, fatty acid salts, fatty acid derivatives, alkyltrialkoxysilane and/or a dialkyldialkoxysilane, wherein the alkyl group being a C₆- to C₁₂- alkyl group and the alkoxy group being a methoxy, ethoxy, propoxy and/or a butoxy group, optionally one or more components iib) selected from the group of water-insoluble polymer, water-soluble polymer, carrier and filler, and optionally one or more components iic), and c) 0-70 wt % of adjuvants iii), said adjuvant iii) being in powder form, wherein thickener i), component ii) and adjuvants iii) are different powders and the added components sum up to 100 wt %, based on the total amount of the powder mixture. The invention further provides a process to make a dry mortar comprising a hydraulic and/or latent hydraulic setting binder and the powder mixture according to the invention, wherein the mixture is made first, followed by mixing it with the binder. The powder mixture and the process provide an easy quality control means to ensure the presence of the component in the dry mortar.

The present invention relates to a powder mixture suitable for hydrophobizing and thickening cementitious mortars, comprising a water-thickener in powder form and another component, i.e. a functional additive, in powder form, a process to make a dry mortar comprising the mixture and a binder, the dry mortar obtainable according to said process, as well as the use of the dry mortar as specified mortars. Said mixture and said process provide an easy quality control means to determine the presence of the component in the dry mortar.

Mortars are nowadays widely used in building applications. They comprise of a binder, typically a mineral binder such as cement, fillers and/or aggregates with a grain size of up to 4 mm diameter and optionally further constituents, additives or adjuvants. Mortars find their use typically as adhesive mortars and coating mortars.

Furthermore, mortars often contain further additives to boost their performance. Thickeners, in particular water-thickeners, are a class of key ingredients which are added. They increase the viscosity of the water-phase and thus provide mortars a suitable rheological profile. Some thickeners, e.g. such as cellulose ethers, further equip mortars with an increased water retention and/or stabilization of air pores.

High performance building material compositions may further contain one or more functional additives, e.g. to reduce water absorption of the cured mortar, and/or to render the cured mortar hydrophobic, i.e. water-repellent.

Such functional additives are very efficient and thus only small amounts, e.g. below 1 wt % or even well below 0.1 wt %, based on the total amount of dry mortar, are added to the building material composition for achieving the desired effect. However, this leads to the difficulty of knowing whether or not such functional additives have been indeed added already during the manufacturing process of the building material composition. This is particularly revealed when trying to make quality control measurements to confirm whether or not these functional additives have been added already and, when added, in their right amounts. In case this needs to be investigated, lengthy application tests would need to be performed which last typically days, if not even weeks or months.

It was therefore the objective of the present invention to provide means for a fast and easy detection of whether or not the functional additive has been added to the building material composition, preferably also indicating the amount it was added in.

Surprisingly it was found that the purpose of the invention can be achieved by a powder mixture comprising
a) 5-90 wt % of one or more water-thickeners i), said thickener i) being in powder form and selected from the group of starch, starch ether, poly(meth)acrylate, polyurethane, associative thickeners, sulfo-group containing thickeners, cellulose ether and or guar ether, wherein the cellulose ether and the guar ether are modified with alkyl, hydroxyalkyl and/or carboxymethyl groups, wherein the alkyl groups are selected from methyl, ethyl, propyl and/or C₈- to C₃₀- alkyl groups and the hydroxyalkyl groups are selected from hydroxyethyl and/or hydroxypropyl groups,
b) 5-90 wt % of one or more components ii), wherein component ii) is in powder form and comprises
   one of more components iia) selected from the group of organosilicon compounds, fatty acids, fatty acid salts and fatty acid derivatives, wherein the organosilicon compound is an alkyltrialkoxysilane and/or a dialkyldialkoxysilane, the alkyl group being a C₆- to C₁₂- alkyl group and the alkoxy group being a methoxy, ethoxy, propoxy and/or a butoxy group,
   optionally one or more components iib) selected from the group of a water-insoluble polymer, water-soluble polymer, carrier and filler, and
   optionally one or more components iic), and
c) 0-70 wt %, preferably 0-50 wt %, of adjuvants iii), said adjuvants iii) being in powder form, and
   wherein thickener i), component ii) and adjuvants iii) are different powders and the added components sum up to 100 wt %, based on the total amount of the powder mixture. Suitable these mixtures are used for hydrophobizing and thickening cementitious mortars.

The powder mixture of the invention typically does not demix when handled the normal way. Thus, no special care needs to be taken for storage, transportation and processing. Furthermore, the powder mixture of the invention as well as the process of the invention, allows surprisingly easy detection of the presence of the component ii), i.e. the functional additive, in the building material composition, while this is not possible with such an ease and within minutes when the functional additive is not combined with the water-thickener i) and one or more components ii). Surprisingly, it was found that by measuring the viscosity of the water-mixed building material composition comprising the powder mixture of the invention, the presence of both, the water-thickener and the one or more component ii) can be determined easily. Further, this method allows unexpectedly a fairly accurate determination of the added amounts, which is within about 10% or less. Thus, a straight forward and easy-to-handle quality control means is provided by the mixture according to the invention.

Claimed also is a process to make a dry mortar and the dry mortar obtainable according to said process, comprising a hydraulic and/or latent hydraulic setting binder and said mixture, wherein the mixture is made first, i.e. separate, followed by mixing the obtained mixture with the binder. The resulting dry mortar may contain further ingredients which may be mixed in before, during and/or after the admixing of the mixture of the invention. Said dry mortar may, typically on the building site, be further mixed with water and allowed to cure.

It was surprising to find that the mixture of the invention can be made with conventional powder mixers and powder blenders, which are well known to the skilled person in the art. Further, the water-thickener i), the component ii) and the optional adjuvants iii), when combined with each other to form the powder mixture according to the invention, form together a bigger volume and larger weight in comparison to the individual components i), ii) and iii) when added separately. Therefore, the combined addition as a mixture allows—beside the easy quality control—a more exact metering in of the components. Thus, the process of the invention provides building material compositions with a higher quality level, i.e. having a lower standard deviation of the amounts of thickener i) and component ii) in comparison of adding the single components separately.

It is noted that WO-A-2004/103928 discloses a hydrophobing additive, based on fatty acids and derivatives thereof, comprising a) 30 to 95 wt. % of one or more water-soluble protective colloids, b) 5 to 70 wt. % of one or more compounds from the group comprising b1) fatty acids and fatty acid derivatives, which release fatty acids or the corresponding fatty acid anion in alkaline conditions, optionally, in combination with b2) one or more organosilicon compounds and c) 0 to 30 wt. % of an antiblocking agent. However, this additive is only one type of powder. Powder admixtures with thickeners are not disclosed.

EP-A-1982964 discloses a mixture of a water soluble organic polymer and an organosilicium compound which is an oligomeric alkyl-alkoxy siloxane. The mixture may be in powder form and protects substrates from corrosion.

WO-A-2010/052201 discloses a powder comprising an organosilane and a carrier material suitable for hydrophobising mortars, e.g. gypsum-based mortars, wherein the amount of cement in the final formulation is zero or less than 5 wt %. The organosilane is an alkyltrialkoxysilane or a dialkyldialkoxysilane with a C₁- to C₄- alkyl group and the carrier material is a water-soluble polymer. Such alkylalkoxysilanes having such a short alkyl group are not suitable for cement-based formulations, since they do not provide any significant hydrophobicity nor a reduced water absorption. And to the contrary, alkylalkoxysilanes with a C₆- to C₁₂- alkyl group do not provide any significant hydrophobicity nor a reduced water absorption in formulations with no cement such as gypsum-based formulations.

The water-thickener i)

The water-thickener i), in short thickener i) or component i), thickens aqueous solutions. Such thickeners are well known to the skilled person in the art. The thickeners of the invention are chosen from starch, starch ether, poly(meth)-acrylate, polyurethane, associative thickeners, sulfo-group containing thickeners, cellulose ether and or guar ether, wherein the cellulose ether and the guar ether are modified with alkyl, hydroxyalkyl and/or carboxymethyl groups, wherein the alkyl groups are selected from methyl, ethyl, propyl and/or C₈- to C₃₀- alkyl groups and the hydroxyalkyl groups are selected from hydroxyethyl and/or hydroxypropyl groups. The thickener i) is according to the invention in powder form and is a different powder than component ii) and adjuvent iii).

The thickener i) amounts 5 to 90 percent by weight ( wt %), preferably 10 to 80 wt %, in particular 15 to 75 wt %, based on the total amount of the powder mixture.

The thickener i) may be of natural origin or it may have been synthetically prepared. These thickeners i) are in general solids at room temperature and preferably have a high molecular weight. They typically have a bulk density of about 200 g/l or higher, in particular of about 400 g/l and higher. Furthermore, they are preferably cold water-soluble or cold water-swellable. In mortars, the thickeners i) are typically used in an amount of about 0.01 to 3 wt % and provide water retention and/or help to adjust the required rheology profile, which involves a thickening of the aqueous phase. They often provide a shear thinning character to mortars, when mixed with water. The exact types of polysaccharide used vary and depend on the specific application. They are well known to the person skilled in the art, who also is well capable of making the proper selection.

In an embodiment, the thickener i) has a Brookfield viscosity of at least 500 mPas, preferably of at least 1000 mPas and in particular at least 2000 mPas, measured at 20° C./ 20 rpm and as a 2 wt % aqueous solution at pH 7 and/or pH 12. When measured at pH 7, the pH is, if required, adjusted with preferably a weak acid or base, which is well known to the skilled person in the art. When measured at pH 12, the pH is adjusted using an aqueous NaOH-solution or the thickener is already dissolved in an aqueous pH 12 solution. In order to avoid any ambiguity, it is preferred to use distilled water to determine Brookfield viscosities.

When the thickener i) is a starch or a starch ether, it may be physically and/or chemically modified. Physical modifications include thermal treatment which is typical for e.g. starches to obtain cold water-soluble starches.

In another embodiment, the thickener i) is a physically modified starch, in particular cold water-soluble starch, and derivatives thereof.

In yet another embodiment, the thickener i) is a cellulose ether and/or guar ether. The cellulose ether and/or guar ether are modified with alkyl groups and/or hydroxyalkyl groups, wherein the alkyl groups comprise methyl, ethyl and/or propyl groups, preferably methyl and/or ethyl groups, and optionally in addition C₈- to C₃₀- alkyl groups, preferably C₁₂- to C₂₄- alkyl groups. The hydroxyalkyl groups are hydroxyethyl and/or hydroxypropyl groups.

Preferred cellulose ethers and guar ethers are methyl cellulose, ethyl cellulose, hydroxyethyl cellulose, hydroxypropyl cellulose, hydroxyethyl hydroxypropyl cellulose, methyl hydroxyethyl cellulose, ethyl hydroxyethyl cellulose, methyl ethyl hydroxyethyl cellulose, methyl hydroxyethyl hydroxypropyl cellulose, ethyl hydroxyethyl hydroxypropyl cellulose, methyl ethyl hydroxyethyl hydroxypropyl cellulose, carboxymethyl cellulose, hydroxyethyl guar, hydroxypropyl guar, methyl guar, ethyl guar, methyl hydroxyethyl guar, methyl hydroxypropyl guar, ethyl hydroxyethyl hydroxypropyl guar, ethyl hydroxypropyl guar, carboxymethyl guar and mixtures thereof.

In another embodiment, the cellulose ethers and guar ethers have a degree of substitution (DS) of the alkyl groups of between 0.1 and 2.5, preferably of between 0.15 and 2.2 and in particular between 0.2 and 2.0, and a molecular substitution (MS) of hydroxyalkyl groups of between 0.05 and 5.0, preferably between 0.1 and 4.0 and in particular between 0.2 and 3.5.

The viscosity of the cellulose and guar ether to be used is an important means for providing the required rheological profile of the building material, coating and/or adhesive composition. The Brookfield viscosity of the cellulose and guar ethers, measured at 20 rpm and as a 2% aqueous solution at 20° C., is preferably between about 500 and 200,000 mPas, particularly between about 1,000 and 150,000 mPas, and in particularly preferred manner between about 5,000 and 100,000 mPas.

Non-limiting examples of sulfo-group containing thickeners are e.g. disclosed in EP 728781 and EP 1309634. Apart from the embodiment as claimed, the thickener i) may be from the group of polysaccharides and polysaccharide ether alginate, xanthan gum, welan gum, diutan gum, poly(meth)acrylamide, polyvinyl alcohol, polyvinyl acetal, polyvinyl pyrrolidone, polyalkylene glycol, polyalkylene oxide, agar-agar, carob seed grain, pectin, gelatine and soy protein. The term polyvinyl alcohol includes modified or unmodified, fully or partially hydrolyzed polyvinyl alcohol. The molecular weight, measured as MW_{w}, is preferably 150,000 and above, in particular 200,000 and above, and may range up to 1,000,000 or more. Such polyvinyl alcohols and their combination with cellulose ether are e.g. described in EP 1180535.

The component ii)

The powder mixture of the invention may comprise one or more components ii), i.e. functional additives, in powder form, in an amount of 5 to 90 wt %, preferably 10 to 80 wt %, in particular 15 to 75 wt %, based on the total amount of the powder mixture.

The component ii) is in powder form and is or comprises itself one or more components iia) which are at room temperature a liquid, a solid or a paste. Component ii) may further optionally comprise one or more components iib) and/or one or more components iic).

In one embodiment, the thickener i) and the component ii) of the mixture according to the invention have a mean volumetric particle size, measured according to ISO 13320:2009, of between 20 μm and 500 μm, preferably between 50 μm and 350 μm, and more preferably between 70 μm and 200 μm, since such ranges gave excellent mixing with mortars.

In another embodiment the component ii) comprises less than 20 wt %, preferably less than 10 wt %, and particularly preferred less than 2 wt %, and most preferred even 0 wt % of an organosiloxane, such as an oligomeric organosiloxane, based on the total amount of organosilicon compound.

In another embodiment, the mean volumetric particle size of the thickener i), which is in powder form, differs not more than 10 times, preferably not more than 7 times, in particular not more than 5 times, from the mean volumetric particle size of the component ii), which is also in powder form, wherein the mean volumetric particle size being measured according to ISO 13320:2009. It was surprisingly found that due to the fact that the mean particle size of the coarser particle is not more than 10 times the size of the mean particle size of the finer particle, the risk of demixing of the particles is reduced significantly—or is even taken away completely. Since demixing is prevented to a large extent, the composition of the mixture remains constant during transport and storage.

The skilled person is well aware of techniques to mix two powders, i.e. the thickener i) with the component ii). These techniques are well known and established.

In an embodiment, component ii) comprises of 5 wt % to 100 wt %, preferably 10 wt % to 100 wt %, in particular 15 wt % to 100 wt % of component iia). The remainder is one or more components iib) and/or components iic), wherein the sum of components iia), iib) and iic) sum up to 100 wt %, based on the total amount of component ii).

In yet another embodiment, component ii) comprises 100 wt % of component iia). In this embodiment, component iia) is preferably a solid and has a melting point of 40° C. or higher and is at room temperature in powder form. Hence, component iia) may be used as such and thus it is then component ii). Non-limiting examples of such components iia) are fatty acid salts.

In another embodiment, component ii) comprises 0 to 20 wt % , preferably 0 to 10 wt % and in particular 0 to 5 wt %, of component iic) wherein the sum of components iia), iib) and iic) sum up to 100 wt %, based on the total amount of component ii).

In even another embodiment, component ii) comprises component iia) and component iib) and optionally component iic), wherein component iib) is a carrier and component iia) is being adsorbed on said carrier to form a powder, independent on the melting point of component iia). This embodiment is particular suitable when component iia) is an alkyltrialkoxysilane and/or a dialkyldialkoxysilane.

Yet in another embodiment, component ii) comprises component iia) and component iib) and optionally component iic), wherein component iib) is a water-soluble polymer and component iia) is being encapsulated in said water-soluble polymer powder, independent on the melting point of component iia). This embodiment is also particular suitable when component iia) is an alkyltrialkoxysilane and/or a dialkyldialkoxysilane.

When component iia) is adsorbed on a carrier or encapsulated in a water-soluble polymer powder, the weight ratio of the component iia) to the carrier, i.e. component iib), or the weight ratio of the component iia) to the water-soluble polymer powder, i.e. component iib), is preferably between 10 to 90 and 80 to 20, in particular between 20 to 80 and 70 to 30 and most preferably between about 30 to 70 and about 70 to 30.

The skilled person is well aware of techniques to adsorb component iia) on a carrier and techniques to emulsify component iia) with a synthetic water-soluble polymer in water.

The component iia)

Component iia) is selected from the group of organosilicon compounds, fatty acid, fatty acid salt, fatty acid derivative and mixtures thereof, wherein the organosilicon compound is an alkyltrialkoxysilane and/or a dialkyldialkoxysilane.

Component iia) provides to the cured and hardened mortar—among others—hydrophobic properties to the surface and the bulk of the cured mortar matrix, reduced water absorption, increased adhesion to the substrate and increased cohesion of the cured matrix. Preferably, the hydrophobic properties are present on the mortar surface as well as in the bulk of the mortar.

The organosilicon compound is an alkylalkoxy silane e.g. of the formula RSi(OR′)₃, i.e. an alkyltrialkoxysilane. and/or R₂Si(OR′)₂, i.e. an dialkyldialkoxysilane.

The alkyl groups R of the alkyltrialkoxysilane, i.e. RSi(OR′)₃, and of the dialkyldialkoxysilane, i.e. R₂Si(OR′)₂, may be the same or different. They can be linear, branched and/or cyclic alkyl groups being a C₆- to C₁₂- alkyl group. Particularly preferred are n-hexyl, n-octyl, i-octyl and lauryl groups. The alkoxy groups OR′ are methoxy, ethoxy, propoxy and/or a butoxy groups, wherein methoxy, ethoxy and propoxy groups are preferred and the methoxy and ethoxy groups are particularly preferred.

Non-limiting examples of alkyltrialkoxysilanes and dialkyldialkoxysilanes include hexyl-, n-octyl- and/or i-octyl-trimethoxysilane; hexyl-, n-octyl- and/or i-octyl-triethoxysilane; hexyl-, n-octyl- and/or i-octyl-tripropoxysilane; hexyl-, n-octyl- and/or i-octyl-tributoxysilane; hexyl-, n-octyl- and/or i-octyl-dimethoxy-ethoxysilane; hexyl-, n-octyl- and/or i-octyl-dimethoxypropoxysilane; hexyl-, n-octyl- and/or i-octyl-dimethoxybutoxysilane; hexyl-, n-octyl- and/or i-octyl-diethoxymethoxysilane; hexyl-, n-octyl- and/or i-octyl-diethoxypropoxysilane; butyl-, hexyl-, n-octyl- and/or i-octyl-diethoxybutoxysilane; hexyl-, n-octyl- and/or i-octyl-dipropoxymethoxysilane; hexyl-, n-octyl- and/or i-octyl-dipropoxyethoxysilane; hexyl-, n-octyl- and/or i-octyl-dipropoxybutoxysilane; hexyl-, n-octyl- and/or i-octyl-dibutoxymethoxysilane; hexyl-, n-octyl- and/or i-octyl-dibutoxyethoxysilane; and/or hexyl-, n-octyl- and/or i-octyl- dibutoxypropoxysilane; dihexyl-, dioctyl-dimethoxysilane; dihexyl-, dioctyl-diethoxysilane; dihexyl-, dioctyl-dipropoxysilane; dihexyl-, dioctyl-dibutoxysilane; with octyltrimethoxysilane and octyltriethoxysilane being particularly preferred, wherein n-octyltriethoxysilane and i-octyltriethoxysilane being most preferred.

The fatty acids and fatty acid salts comprise carboxylic acids and their salts with a long aliphatic chain, which is saturated or unsaturated, linear or branched. Preferred fatty acids are C₄- to C₂₈-carboxylic acids, wherein C₈- to C₂₂-carboxylic acids are particularly preferred, and C₁₂- to C₁₈-carboxylic acids are mostly preferred. Preferred fatty acid salts comprise the lithium, sodium, potassium and calcium salts of said carboxylic acids.

Non-limiting examples of saturated acids and fatty acid salts include caprylic acid, capric acid, lauric acid, myristic acid, palmitic acid, stearic acid, arachidic acid, behenic acid, lignoceric acid, cerotic acid and there salts, in particular their lithium, sodium, potassium and calcium salts.

Non-limiting examples of unsaturated fatty acids and fatty acid salts include myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid and there salts, in particular their lithium, sodium, potassium and calcium salts.

The fatty acid derivatives include in particular esters, amides and anhydrides of said saturated and unsaturated fatty acids.

Suitable fatty acid esters include fatty acid esters of C₁- to C₂₂- alkyl- and/or aryl- esters with alkyl- standing for a linear, branched and/or cyclic alkyl- and/or aryl- group. Preferred fatty acid esters comprise carboxylic esters of the formula CₙH₍₂ₙ₊₁₎COOCₘH₍₂ₘ₊₁₎ and CₙH₍₂ₙ₋₁₎COOCₘH₍₂ₘ₊₁₎, where n and m are integers with n having a value of 6 to 22 and m having a value of 1 to 8, preferably n=10 to 18 and m=1 to 6, in particular n=10 to 16 and m=1 to 4. Methyl laurate and/or ethyl laurate are particularly preferred as carboxylic acid ester.

Fatty acid amides include fatty acid amides obtained by the reaction of carboxylic acids with alkanol amines, in particular mono- and/or di-ethanol amine, wherein preferred carboxylic acids include C₄- to C₂₈-carboxylic acids, in particular C₈- to C₂₂-carboxylic acids, and mostly preferred are C₁₂- to C₁₈-carboxylic acids.

Preferred fatty acid anhydrides include fatty acid anhydrides of saturated or unsaturated, linerar or branched fatty acids, preferably of C₄- to C₂₈-carboxylic acids, in particular of C₈- to C₂₂-carboxylic acids, and most preferably of C₁₂- to C₁₈-carboxylic acids. They are preferably used in mortars with, when mixed with water, an alkaline environment, where they are hydrolyzed to result in the respective carboxylic acid or salts thereof.

Apart from the embodiments as claimed, the following materials can be considered as compounds iia):
Organosilicon compounds alkylalkoxysiloxane of the formula (R″)Si(OR′″)xOy, a fluoroorganic-substituted silicon compound such as a fluoroalkylalkoxy silane, silicic acid esters having the formula Si(OR′)4, polysilanes of the formula R3Si(SiR2)nSiR3 where R is n=0 to 500, n=0 to 8 being preferred, di-, oligo- and polysiloxanes or their mixtures of the general formula or empirical formula RcHdSi(OR′)e(OH)fO(4-c-d-e-f)/2 where c=0 to 3, d=0 to 2, e=0 to 3, f=0 to 3 and the sum c+d+e+f is at most 3.5, R′ in each case independently being an alkyl or alkoxyalkylene radical having 1 to 4 C atoms and may be methyl or ethyl, groups R being identical or different and being branched or straight-chain alkyl radicals having 1 to 22 C atoms, cycloalkyl radicals having 3 to 10 C atoms, alkylene radicals having 2 to 4 C atoms, aryl, aralkyl or alkylaryl radicals having 6 to 18 C atoms, it being possible for said radicals R also to be substituted by halogens, such as F or Cl, by ether, thioether, ester, amide, nitrile, hydroxyl, amine, carboxyl, sulfonic acid, epoxide, carboxylic anhydride and carbonyl groups, it also being possible for R to have the meaning OR′ in the case of the polysilanes, organosilicon compounds selected from the group of alkyltrialkoxysilane, dialkyldialkoxysilane, alkylalkoxysiloxane, a mixture of alkylalkoxysiloxanes and/or a fluoroalkyltrialkoxysilane, alkylalkoxysiloxane of the formula RSi(OR′)ₓO_{y}, x and y are preferably within 1.0<x<2,0 and 0.5<y1.0, wherein (2y+x)=3. Said alkylalkoxysiloxane can be an oligomer mixture of oligomerized alkylalkoxysilane, wherein 70 to 100 wt. %, or even 80 to 99 wt. %, of said oligomer mixture has a degree of oligomerisation between 2 and 10, or even 3 and 6,
Alkyltrialkoxysilane of the formula RSi(OR′)₃, with R being e.g. a C₁- to C₁₈- alkyl group, or C₁- to C₁₂- alkyl group and R′ being e.g. a C₁- to C₄- alkyl group, or a C₁- to C₃- alkyl group,
Fluoroorganic-substituted silicon compounds may be from the group of fluoroorganic-substituted silanes and fluoroorganic-substituted siloxanes and mixtures thereof including fluoralkyl-substituted monosilanes, fluoralkyl-substituted monosiloxanes and mixtures thereof. The fluoroorganyl-substituted silicon compound may be a fluoroalkylalkoxysilane of the formula

F3C(CF2)x(C2H4)ySi(CH3)z(OR′)3-z, wherein each R′ is selected independently from the group consisting of methyl, ethyl, n-propyl, and i-propyl, x is an integer with a value of 0 to 16, y=0 or 1, and z=0 or 1, preferably y=1, and in particular y=1, z=0, and x=3, 4, 5, 6, 7, 8 or 10. The fluoroorganyl-substituted silicon compound provides to the cured mortar so-called easy-to-clean properties, i.e. the mortar surface as well as the bulk of the mortar becomes not only water-repellent, i.e. hydrophobic, but also oil-repellent, i.e. oleophobic.
Diterpenes include abietic acid, neoabietic acid, levopinaric acid, pimaric acid, isopimaric acid, dehydroabietic acid, dihydroabietic acid, sylvic acid, palustric acid, rosin, isopimaric acid, aphidicolin, cafestol, cembrene, ferruginol, forskolin, guanacastepene A, kahweol, labdane, lagochilin, sclarene, stemarene, steviol, taxadiene, tiamulin, retinal, tretinoine, agelasine E, agelasidine B, oxocativic acid, pinifolic acid, labdenic acid, dihydroxyhalimadieic acid, epoxyclerodatrienic acid, isopimaradienic acid, junceic acid, podocarpic acid, cassainic acid, cassaidin, cassain, cassamin, auricularic acid, cleistanthadienic acid, isocopalendial, abtietadienic acid, as well as their mixtures and derivatives thereof. The diterpenes may be derivatized with suitable groups, including alkyl ester and alkyl ether groups, such as C1- to C22- alkyl ester groups and or even C1- to C12- alkyl ester groups, alkoxylated ester and ether groups with alkoxy groups having alkyl and/or hydroxyalkyl end groups, with the alkoxy group preferably being a C1- to C4- alkoxy group. Furthermore, the diterpene may be functionalized with one or more carboxyl, sulfo, epoxide, maleic acid, fumaric acid, triethylene glycol esters, penta esters, glycerol esters, salicyl alcohol, 2-hydroxybenzyl alcohol, and/or acrylic groups. In addition, the diterpene derivative can be a disproportionated diterpene, a hydrogenated diterpene, a metal rosinate, the metal being in particular calcium or zinc, a styrenated rosin and/or an oxidized rosin. Diterpene derivative may have an acid number according to DIN EN ISO 2114 of about 75-300 mg KOH/g, or even about 100-240 mg KOH/g. Diterpene and/or derivatives thereof, provide to the cured and hardened mortar strongly reduced tendency for efflorescence, in particular in cement-based cured mortars, and/or hydrophobic properties, in particular in gypsum-based cured mortars, of the surface and the bulk of the cured mortar matrix, as well as reduced water absorption of the mortar matrix,
quaternary ammonium salts which may be of the formula (N+R1R2R3R4)A-, (N+R1R2R3R4)2A2-, or (N+R1R2R3R4)3A3-, wherein R1, R2, R3 and R4 represent each an organic group with at least one C-atom and they may be the same or different. A- stands for a monovalent, A2- for a divalent, and A3- for a trivalent anion. Anions A- may be fluoride, chloride, bromide, iodide, hydroxide, methyl sulfate, hydrogen carbonate and/or dihydrogen phosphate. Divalent anions A2- may be sulfate, carbonate and/or hydrogen phosphate. A trivalent anion A3- may be phosphate. The organic groups R1, R2, R3 and/or R4 are saturated or unsaturated, linear, branched or cyclic alkyl groups which may be the same or different, wherein R1, R2, R3 and/or R4 may comprise a saturated or unsaturated C1- to C4- alkyl group, such as a methyl or ethyl group, and/or at least one of R1, R2, R3 and/or R4 comprises a saturated or unsaturated, linear, branched, cyclic and/or aromatic alkyl and/or heteroalkyl group, which is a C6- to C50-group, preferably a C6- to C40- group, in particular a C8- to C30- group, and most preferably a C8- to C24- group. Alkylammonium compounds may include alkyltrimethyl ammonium salts such as cetyltrimethylammonium bromide or chloride, dialkyldimethyl-ammonium salts, benzalkonium salts such as benzalkonium chloride, ester quats, which generally are based on quaternary triethanol-methyl-ammonium or quaternary diethanol-dimethyl-ammonium compounds, ethoxylated quaternary organic ammonium compound, as well as organobentonites,
Glycol ethers of the formula HO-(R1O)m-H and R2O-(R3O)n-H, wherein R1 is a linear and/or branched C2- to C6- alkylene group, R2 is a linear, branched and/or cyclic C1- to C6- alkyl group, R3 is a C2- to C4- alkylene group and the same as or different from R1, m and n are integers of 1 to 4, in particular 2 or 3, and the same or different. R1 includes the divalent radicals of ethane, n-propane, isopropane, n-butane, isobutene and/or tertiary butane. R2 includes methyl, ethyl, n-propyl, isopropyl, n-butyl, isobutyl, tertiary butyl, n-pentyl, isopentyl, cyclopentyl and/or cyclohexyl groups, R3 includes linear and branched C2- to C4- alkylene group, wherein R3 is the same as or different to R1. Glycols and glycol ethers include ethylene glycol, diethylene glycol, triethylene glycol, trimethylene glycol, propylene glycol, dipropylene glycol, tripropylene glycol, neopentyl glycol, pentanediol, hexanediol and their monoethers with the organic remainder of the ether group being the same or different and preferably being a methyl, ethyl, n-propyl, isopropyl, n-butyl, isobutyl, tertiary butyl, n-pentyl, isopentyl, cyclopentyl and/or cyclohexyl group.

The Component iib)

The addition of the one or more components iib) is optional. However, the presence of one or more components iib) is particularly preferred when component iia) is a liquid or a paste at 40° C. or below. Component iib) is selected from the group of a water-insoluble polymer, water-soluble polymer, carrier and filler. According to the present invention, the term carrier as component iib) denotes a powdery material which serves as and is used to adsorb component iia) when component iia is not a powder itself. The term filler as component iib) denotes a powdery material which serves and is used as filler, but not as carrier. The term filler comprises according to the invention also anticacking agents. However, carriers and fillers comprise the same compounds.

The carrier that can be used in the present invention is preferably an inorganic carrier or filler. Examples of inorganic carriers or fillers are alumosilicate, silicon oxide, silicon dioxide, aluminium silicon oxide, calcium silicate hydrate, aluminium silicate, magnesium silicate, magnesium silicate hydrate, magnesium aluminium silicate hydrate, mixtures of silicic acid anhydrite and kaolinite, aluminium silicate hydrate, calcium aluminium silicate, calcium silicate hydrate, aluminium iron magnesium silicate, calcium carbonate, calcium magnesium carbonate, calcium metasilicate. anticacking agents, particulate titanium dioxide, expanded perlite, cellite, cabosil, circosil, aerosil, eurocell, fillite, promaxon, china clay, dolomite, limestone powder, chalks, layered silicates and/or precipitated silicas. Preferred are silicate, silicon dioxide, silica fume, fumed silica, carbonates, kaolin and/or china clay and most preferred are silicate, silicon dioxide and/or fumed silica.

In an embodiment the carrier has a primary particle size diameter (PSD) of below 1 micrometer. It can be as small as e.g. 0.1 μm or lower, but in general, due to the toxicity associated with the respiration of small dust particles and for handling reasons, it is preferred that these primary particles easily form aggregates and as such have—as aggregates—particle sizes, measured e.g. by light scattering or light diffraction, such as e.g. ISO 8130-1, of e.g. 10 to 300 μm, preferably 15 to 200 μm.

When component iib) is a carrier, it has preferably a BET surface area, measured according to ISO 5794-1, of at least 10 m²/g, preferably of at least 50 m²/g, in particular of at least 75 m²/g, and most preferably of at least 100 m²/g. In one embodiment the BET surface area can be as high as up to 1,000 m²/g, preferably it ranges up to 600 m²/g.

When component ii) comprises component iia) being adsorbed on a carrier, it forms in general a free-flowing and storage stable powder, which imparts a good wettability when in contact with water.

When component iia) is encapsulated in a water-soluble polymer powder iib), it is in one preferred embodiment obtained by mixing with an aqueous medium comprising a water-soluble polymer and dried. The water-soluble polymers are most typically solids at room temperature and preferably have a molecular weight of about 1,000 or higher, in particular of about 5,000 or higher. Their water solubility, measured at 20° C. and in distilled water and at pH 7, is more than 4 g/l, in particular more than 10 g/l, and most preferably more than 50 g/l.

In one embodiment, the water-soluble polymers may be selected from components from the group of thickener i). It is, however, essential according to the invention that the thickener i) is one powder and component ii) comprising the component iia) and optionally component iib), e.g. a water-soluble polymer, and optionally component iic), is another, distinct different and thus separate powder. Thus, in case the same water-soluble polymer would be used as thickener i) as well as component iib) as part of component ii), the water-soluble polymer has a different function and works—when being component iib)—as stabilizer of component iia) and therefore acts not anymore as thickener.

In another embodiment, the water-soluble polymer iib) is different from thickener i).

In yet another embodiment, the water-soluble polymer has a Brookfield viscosity of less than 500 mPas, measured at 20° C. and 20 rpm as a 2 wt % aqueous solution having a pH of 7.

When several water-soluble polymers, i.e. component iib), are used, use can also be made of a combination of one or more biopolymers with one or more synthetic water-soluble polymers. The latter typically have a bulk density of about 200 g/l or higher, in particular of about 400 g/l and higher. Hollow solid polymer particles are less preferred.

Synthetic water-soluble polymers, i.e. component iib), include one or more polyvinyl pyrrolidones and/or polyvinyl acetals with a molecular weight of 2,000 to 400,000, fully or partially saponified polyvinyl alcohols and their derivatives, which can be modified for instance with amino groups, carboxylic acid groups and/or alkyl groups, with a degree of hydrolysis of preferably about 70 to 100 mol. %, in particular of about 80 to 98 mol. %, and a Höppler viscosity in 4% aqueous solution of preferably 1 to 100 mPas, in particular of about 3 to 50 mPas (measured at 20° C. in accordance with DIN 53015), as well as melamine formaldehyde sulfonates, naphthalene formaldehyde sulfonates, polymerizates of propylene oxide and/or ethylene oxide, including their copolymerizates and block copolymerizates, styrene-maleic acid and/or vinyl ether-maleic acid copolymerizates. Preferred synthetic water-soluble polymers are fully or partially saponified polyvinyl alcohols and their derivatives, polyvinyl pyrrolidone, polyvinyl acetal, melamine formaldehyde sulfonates, naphthalene formaldehyde sulfonates, polymerizates of propylene oxide and/or ethylene oxide, including their copolymerizates and block copolymerizates, styrene-maleic acid and vinyl ether-maleic acid copolymerizates. Most preferred are partially saponified, optionally modified, polyvinyl alcohols with a degree of hydrolysis of 80 to 98 mol. % and a Höppler viscosity as 4% aqueous solution at 20° C. of 1 to 50 mPas and/or polyvinyl pyrrolidone. In one preferred embodiment, at least 50 wt %, preferably at least 75 wt %, of the polyvinyl alcohol employed has a molecular weight, measured as MW_{w}, of 100,000 or less, in particular of 75,000 or less, most preferably of 50,000 or less.

Water-soluble polymers which are biopolymers or chemically modified biopolymers include polysaccharide, polysaccharide ether, cellulose ether, guar ether, starch, starch ether, alginate, carboxymethyl cellulose, agar-agar, carob seed grain, pectin, gelatine and soy protein. Preferred are dextrines, cellulose ether, guar ether and starch ether having a Brookfield viscosity of less than 500 mPas, measured at 20° C. and 20 rpm as a 2 wt % aqueous solution having a pH Of 7.

The drying of the admixture of component iia) with the aqueous medium comprising a water-soluble polymer, i.e. component iib), can take place by means which are well known to the skilled person. Preferred are spray drying, including pulse combustion spray drying, freeze drying, fluidised bed drying, drum drying, dry grinding or flash drying, in which case spray drying is particularly preferred.

According to the present invention, the term water-insoluble polymer, when used, comprises water-dispersible polymers as well as emulsion polymerizates. Their water solubility, measured at 20° C. and in distilled water and at pH 7, is 4 g/l or lower, in particular 1 g/l or lower. Preferred water-insoluble polymers comprise water-redispersible polymer powders, which typically may be obtained by drying, in particular spray drying, emulsion and/or suspension polymerizates. Preferred emulsion and/or suspension polymerizates are (co)polymers of olefinically unsaturated monomers. The latter preferably comprise monomers from the group of vinyl acetate, ethylene, acrylate, methacrylate, vinyl chloride, styrene, butadiene and/or C₄-C₁₂ vinyl ester monomers.

In the context of the invention, film-forming, water-insoluble organic polymer binders based on olefinically unsaturated monomers include vinyl(co)polymers, polyurethanes, poly(meth)acrylates, polyesters, polyethers, as well as mixtures and hybrids thereof. Water-insoluble polymer-binders are water-redispersible polymer powders which may be obtained by drying polymer dispersions. Said dispersions are typically obtained by emulsion and/or suspension polymerization and may contain the vinyl(co)polymers, polyurethanes, poly(meth)acrylates, polyesters, polyethers, as well as mixtures and hybrids thereof. The dispersions may be based on (co)polymers of ethylenically unsaturated monomers preferably comprising monomers from the group of vinyl acetate, ethylene, acrylate, methacrylate, vinyl chloride, styrene, butadiene and/or C4-C12 vinyl ester monomers. Suitable compounds are based on vinyl acetate, ethylene-vinyl acetate, ethylene-vinyl acetate-vinyl versatate, ethylene-vinyl acetate-(meth)acrylate, ethylene-vinyl acetate-vinyl chloride, vinyl acetate-vinyl versatate, vinyl acetate-vinyl versatate-(meth)acrylate, vinyl versatate-(meth)acrylate, pure (meth)acrylate, styrene-acrylate and/or styrene-butadiene, wherein the vinyl versatate preferably is a C4- to C12-vinyl ester, in particular a C9-, C10- and/or a C11-vinyl ester, and the polymerizates can contain about 0-50 wt. %, in particular about 0-30 wt. %, and quite especially preferably about 0-10 wt. % of further monomers, in particular monomers with functional groups.

In an embodiment, said polymerizates and the water-redispersible polymer powders are film-forming at a temperature of 23° C. or higher; preferably at 10° C. or higher; in particular at 5° C. or higher. Film-forming means that the copolymer is capable of forming a film determined according to DIN ISO 2115.

The Component iic)

The addition of the one or more components iic) is optional. Component iic) as such may be at room temperature a liquid, a paste or a solid.

A non-limiting list of components iic) includes inorganic and organic acids, bases and/or their salts, fungicides, bactericides, algicides, biocides and microbiocides, odourants, air entraining agents, wetting agents, defoamers or anti-foaming agents, surfactants, film-forming agents, agents to control cement hydration such as setting and solidification accelerators, setting and solidification retarders, dispersing agents, cement superplasticizers, polycarboxylates and/or polycarboxylate ether.

The adjuvant iii)

The adjuvant iii), i.e. component iii), is in powder form and includes—but is not limited to—aggregates, fillers, anti-caking aids, inorganic and organic acids, bases and/or their salts, fungicides, bactericides, algicides, biocides and microbiocides, odourants, air entraining agents, wetting agents, defoamers or anti-foaming agents, surfactants, film-forming agents, shrinkage reducing agents, agents to reduce efflorescence, agents to control cement hydration such as setting and solidification accelerators, setting and solidification retarders, dispersing agents, cement superplasticizers, polycarboxylates, polycarboxylate ether, cellulose fibres, water-redispersible polymer powder based on film-forming, water-insoluble polymers obtained by emulsion polymerization and/or adjuvants for the reduction of powder caking.

Particularly suitable fillers include limestone powder, carbonates, silicates, chalks, layered silicates, precipitated silicas, light-weight fillers such as for instance hollow microspheres of glass, silicon dioxide, calcium-silicate hydrate, clays such as bentonite and/or vulcanic slag, as well as pozzolanes such as fly ash, metakaolin and/or latently hydraulic components, in which case the fillers and/or light-weight fillers can also have a natural or artificially generated colour.

It is noted that any combination of any one or more embodiments as disclosed above is contemplated for forming a mixture in accordance with the invention, whereby each combination is preferred.

The dry mortar

The dry mortar, which is according to the invention a preferred building material composition, is made according to the process of the present invention and comprises the powder mixture according to the invention preferably in an amount of 0.05 to 10 wt %, based on the total amount of the dry and uncured mortar, and a binder, wherein the binder is a hydraulic and/or latent hydraulic setting binder. The dry mortar according to the invention has a grain size of not more than 4 mm, i.e. at least 98 wt % of the dry mortar passes a sieve having a mesh of 4 mm.

In an embodiment, the hydraulic and/or latent hydraulic binder in the dry mortar amounts 6 to 60 wt %, preferably 10 to 60 wt %, in particular 12 to 50 wt %, based on the total amount of solid components of the uncured mortar. In a particularly preferred embodiment, the binder is cement.

According to the invention, hydraulic setting binders set and harden by chemical interaction with water and are capable of doing so under water.

According to the invention, latent hydraulic binders set by the addition of an activator, usually lime, and water.

In the context of the present invention, the binder comprises a) hydraulically setting binders, in particular cements, activated blast furnace slags and/or silicocalcareous fly ash and/or b) a latent hydraulic binder, such as in particular pozzolanes and/or metakaolin, which reacts hydraulically in combination with a calcium source such as calcium hydroxide and/or cement.

Preferred cements are in particular Portland cement, for instance in accordance with EN 197-1 OEM I, II, III, IV, and V, and/or calcium phosphate cement and/or aluminous cement such as calcium aluminate cement and/or calcium sulfo-aluminate cement.

Preferred latent hydraulic binders or pozzolanes are metakaolin, burnt shale, diatomaceous earth, moler, rice husk ash, air cooled slag, calcium metasilicate and/or volcanic slag, volcanic tuff, trass, fly ash, silica fume, microsilica, blast-furnace slag and in particular ground granulated blast-furnace slag, and/or silica dust.

Particularly preferred binders are hydraulically binding, i.e. setting, materials, in particular Portland cement, or a mixture of Portland cement, calcium aluminate cement, and gypsum.

The dry mortar may comprise in addition to the binder and the mixture according to the invention, one or more fillers and as well as further components, which may be the same or different to the adjuvants iii) from the powder mixture according to the invention.

Suitable fillers, in particular mineral fillers, which are also known under the term aggregates, include quartzitic and/or carbonatic sands and/or powders such as for instance quartz sand and/or limestone powder, carbonates, silicates, chalks, layered silicates, precipitated silicas, light-weight fillers such as for instance hollow microspheres of glass, alumosilicates, silica, aluminium-silica, calcium-silicate hydrate, silicon dioxide, aluminium-silicate, magnesium-silicate, aluminium-silicate hydrate, calcium-aluminium-silicate, calcium-silicate hydrate, calcium-metasilicate, aluminium-iron-magnesium-silicate, clays such as bentonite and/or vulcanic slag, as well as pozzolanes such as metakaolin and/or latently hydraulic components.

The dry mortar may comprise in addition further components, which may be the same or different to the adjuvants iii) added to the powder mixture according to the invention. The skilled person is well aware of these components and is well skilled to choose the optimal amounts to fine-tune the application properties of the dry mortar after being mixed with the required amount of water.

By doing so, he is able to formulate dry mortars according to the invention and use said dry mortar, upon mixing with water, as coating or composite mortar, thermal insulation mortar, base coat mortar, adhesive mortar, decorative mortar, such as e.g. putty, skim coat, renders or monocouche, sealing compound, lime and/or cement plaster, repair mortar, joint adhesive, ceramic tile adhesive, plywood mortar, bonding mortar, cement primer, cementitious coating for concrete, powder coating, parquet adhesive, smoothing compound, troweling compound and/or masonry mortar.

Apart from the embodiments as claimed, non-hydraulic binders may be considered which react under the influence of air and water, in particular calcium hydroxide, calcium oxide, quicklime, hydrated lime, magnesia cements, water glass and/or gypsum, by which is meant e.g. calcium sulfate in the form of α- and/or β-semihydrate and/or anhydrite of form I, II and/or III.

### EXAMPLES

The invention is further elucidated with reference to the following Examples. Unless indicated otherwise, the tests are carried out at a temperature of 23° C. and a relative humidity of 50%.

### Example 1

### Preparation of Powder Mix P1

The ingredients, i.e. the thickener and component ii), i.e. functional additive, of the Powder Mixture P1, were placed into a 500 ml plastic beaker to each amount a total of 150 g of Powder Mix. The type and relative amounts of the ingredients is indicated in Table 1.

The ingredients were then mixed using a 60 mm propeller stirrer at 300 rpm over a period of 10 minutes. A homogeneous, white, dry and free-flowing

Powder Mixture resulted, which showed no signs of separation. Furthermore, it can be easily mixed with the other components of a building material composition, e.g. the dry mortar, either alone or in combination.

TABLE 1
Composition of Powder Mixture P1

| | Thickener | | | Component ii) | | |
|---|---|---|---|---|---|---|
| Powder | | | Amount | | | Amount |
| Mixture | Name | Type | [wt %] | Name | Type | [wt %] |
| P1 | M30^{a)} | MEHEC^{a)} | 50 | SEAL80^{b)} | Organo- | 50 |
| | | | | | silicon^{b)} | |

^{a)}M30 stands for BERMOCOLL ® M30, i.e. thickener i), which is a commercially available MEHEC (Methyl Ethyl Hydroxyethyl Cellulose) from AkzoNobel in powder form. It has a Brookfield viscosity of 60.000 mPas as 2% aqueous solution (Brookfield RV, 20 rpm @ 20° C.) and a mean particle size d(0.5) of 80 μm, measured by means of light diffraction according to ISO 13320:2009 and indicated as volumetric means. BERMOCOLL ® M30 has a degree of substitution (DS) of the alkyl groups, i.e. methyl and ethyl groups, of between 0.2 and 2.0, and the molecular substitution (MS) of the hydroxyethyl groups is between 0.2 and 3.5.
^{b)}Seal80, i.e. component ii), stands for ELOTEX ® SEAL80, which is a commercially available hydrophibizing agent from AkzoNobel in powder form based on an Organosilicon compound, which is an alkyltrialkoxysilane, the alkyl group being a C₆- to C₁₂- alkyl group and the alkoxy group being an ethoxy group. ELOTEX ® SEAL80 comprises of more than 15 wt % component iia) and the remainder being component iib). Said component iib) comprises a water-soluble polymer, wherein component iia) being encapsulated in said water-soluble polymer powder. The weight ratio of the component iia) to component iib) is between 10 to 90 and 80 to 20. Seal80 provides hydrophobicity to cured cement-based building material compositions and has a mean particle size d(0.5) of 99 μm, measured by means of light diffraction according to ISO 13320:2009 and indicated as volumetric means.

It was found that the thickener i) and the component ii) can easily be mixed together with conventional mixing devices. Furthermore, the obtained powder mixture shows good processing behaviour and it can easily be mixed—either alone or in combination—with other components of or with the remainder of the building material composition such as a mortar.

When the thickener i) and component ii) are added to mortars separately, it is often difficult to dose their exact amounts, since they are added in small quantities, e.g. often below 1 wt %. However, when they are mixed beforehand, the total amount of powder mix is larger than the individual components alone. Thus it was found that mixing the thickener i) and the component ii) beforehand and adding the obtained powder mixture makes it easier to dose the exact amounts of thickener i) and component ii), i.e. functional additive.

In order to assess the demixing behaviour, 100 g of the Powder Mixture P1 additive, obtained by homogeneous mixing as described above, was filled into a 250 ml plastic beaker with an inner diameter of 9 cm. The beaker was covered with a lid and fixed in the laboratory sieving machine “Vibro” from Retsch using the clamping yoke. The amplitude of the Retsch instrument was adjusted to 30 (on the 10-100 scale) and the sample was allowed to vibrate. The built-in automated interval device for periodical switching-off the sieving was activated. After 60 minutes, the plastic beaker was carefully removed. The top layer (2-3 g) of the additive in the beaker was rasped away by using a metal spatula, collected and the particle size was analyzed by means of light diffraction. The result was compared with the result from a sample taken after the homogeneous mixing, but before the vibration step. No change of the particle size distribution was observed within the standard deviation, hence the powder P1 shows no signs of demixing.

The same procedure was carried out with a homogeneously mixed 50:50 blend by weight of BERMOCOLL® E431FQ (AkzoNobel), an Ethyl Hydroxyethyl Cellulose with a mean volumetric particle size of 143 μm, and of Sipernat® 22 (Evonik), which is a free-flowing precipitated silica, with a mean volumetric particle size of 11 μm. The samples before and after the vibration step showed distinct different particle size distributions, hence the sample did demix. It is noted that the demixing behavior does not change when a component iia) is adsorbed on said Sipernat® 22.

It is noted that other analytical tests may be used to identify whether or not demixing occurred. A suitable means for additives having ingredients of different viscosities in a solvent is e.g. measuring the viscosity of the samples before and after the vibration step.

It is noted that the same mixing procedure can be applied also when other thickeners i), e.g. other polysaccharides, are used.

### Example 2

### Preparation of the Dry Mortar Master Batch 1

Prepared were 5 kg of a cement-based dry mortar master batch consisting of 30 parts by weight of a commercially available Portland cement CEM I 52.5N and 70 parts by weight of a quartz sand (0.1-0.6 mm), in which process the components were mixed in a 10 l vessel with a FESTO stirrer until a homogeneous dry mortar master batch was obtained.

### Example 3

### Determination of the Consistency by Flow Table of a Mortar Mixed with Water Following EN 1015-3

For each experiment, samples of the dry mortar master batch were dry mixed with the Powder Mix P1, which was prepared according to Example 1 and Table 1. The additive amounts indicated in Table 2 were complemented with the mortar from the dry mortar master batch 1 to yield a total amount of 2 kg of dry mortar. This was homogeneously mixed in a 5 l vessel at 500 rpm using a FESTOOL RW1000 EQ stirrer until a homogeneous dry mortar batch was received.

600 g of the thus obtained dry mortars were mixed with water while stirring using a 70 mm propeller stirrer with a speed of 950 rpm. The added water amount is indicated in Table 2. After completion of the water addition, the mixtures were continued to stir for one minute. Afterwards the mortars were allowed to mature for 5 minutes, followed by mixing the mortar by hand for 15 seconds and introducing it into the mould of the flow table.

The disc of the flow table according to EN 1015-3 was, however, first covered with a polyethylene foil. A truncated conical mould having a height of 60 mm, at the bottom an internal diameter of 100 mm and at the top an internal diameter of 70 mm was placed centrally onto the disc of the flow table. The fresh mortar, which was prepared as described above, was poured into the mould and excess mortar was skimmed off with a palette knife. Afterwards, the mould was slowly raised vertically and the mortar was allowed to spread out on the disc by jolting the flow table 15 times at a constant frequency of approximately one jolt per second. After the last jolt and after the mortar has stopped flowing, the diameter of the mortar was measured in two directions at right angles to one another. The mean value of the two measurements was calculated and recorded as the flow value for each sample.

TABLE 2
The Flow Values (determined as described above in Example 3)
were obtained using the mortar master batch 1 with different
amounts of the Powder Mix P1 (series C). For reference purposes,
flow values were measured with only the component ii), i.e. the
functional additive, (series A) and only the thickener i) (series B),
respectively, instead of their combination (i.e. Powder Mix P1).
The amount of added mixing water was kept constant for all
Examples at an amount of 25 wt %, based on the total amount of
dry mortar, including the additives.

| | Series^{a)} | | | | | |
|---|---|---|---|---|---|---|
| | A (+SEAL80)^{b)} | | B (+M30)^{c)} | | C (+P1)^{d)} | |
| | (comparison Ex.) | | (comparison Ex.) | | (acc. to invention) | |
| | | Flow | | Flow | | Flow |
| Exp. | Amount | Value | Amount | Value | Amount | Value |
| No. | [wt %] | [mm] | [wt %] | [mm] | [wt %] | [mm] |
| 1.1 | 0.0 | >300 | 0.0 | >300 | 0.0 | >300 |
| 1.2 | n.m.^{e)} | n.m.^{e)} | n.m.^{e)} | n.m.^{e)} | 0.3 | 229 |
| 1.3 | 0.2 | >300 | 0.2 | 207 | 0.4 | 207 |
| 1.4 | n.m.^{e)} | n.m.^{e)} | n.m.^{e)} | n.m.^{e)} | 0.5 | 196 |
| 1.5 | 0.3 | >300 | 0.3 | 183 | 0.6 | 184 |
| 1.6 | n.m.^{e)} | n.m.^{e)} | n.m.^{e)} | n.m.^{e)} | 0.7 | 170 |
| 1.7 | 0.4 | >300 | 0.4 | 158 | 0.8 | 159 |

^{a)}The series A and B represent reference Examples comprising only Seal80 (series A) and M30 (series B), respectively. The series C represent Examples according to the invention comprising the powder Mix P1.
^{b)}Comparison Example; see Table 1 for details.
^{c)}Comparison Example; see Table 1 for details.
^{d)}Example according to invention; see Table 1 for details.
^{e)}n.m. stands for “not measured”.

The Flow Values presented from Series A in Table 2 surprisingly indicate that the component ii), i.e. functional additive, ELOTEX® SEAL80 does not impact fresh mortar properties, in particular not the viscosity thereof. This is observed independent on their added amounts, which are added in typical concentrations to achieve the desired technical effect of said functional additive. To the contrary, the mortar viscosities of the mortars with only the thickener (series B), as indicated with the Flow Values, increase with increasing amount of thickener added, which is reflected by reduced Flow Values the more thickener is added (see Exp. 1.1, 1.3, 1.5 and 1.7 of series B). It was now surprisingly found that when the thickener i) and the component ii), i.e. functional additive, are added to the mortar, the mortar viscosity, i.e. the Flow Values, is the same as with the thickener i) alone, based on the same amount of added thickener i) (series C). With other words: When thickener i) and component ii) are added separately, it is not possible to detect whether or not component ii) has been added, or if it was incidentally omitted. However, by first mixing the thickener i) and component ii) in a defined ratio to form a powder mixture and adding this powder mixture to the mortar, it is surprisingly well possible to determine the amount of added component ii) in the mortar by measuring the Flow Viscosities. The latter relate to the amount of added thickener i) which then allows to calculate back the amount of component ii). Thus, in case no component ii) would have been incidentally added to the powder mixture, the powder mixture would contain far too high amounts of thickener i) and thus the mortar viscosity would be far too high, i.g. the Flow Values far too low. And this is then be detected easily. Hence, the combination of the functional additive and the thickener to one single powder mix allows an easy, cost and time efficient method to determine if the functional additive has been added in the proper amount.

Furthermore, the ratio of the thickener i) and the component ii) can also easily be adapted when making the powder mixture according to the invention. This allows with only two different powders the easy and efficient use of different powder ratio in various formulations. This is a real advantage over a process wherein a product is formed having the thickener i) and the component ii) in one fixed ratio.

The measured flow values with Powder Mix P1 as indicated in Table 2 show that the Flow Values correlate very well with the dosage of the Powder Mix and thus with the amount of thickener i) present in the mortar. Since the dosage of the functional additive in the powder mix is known, the addition of Powder Mixes according to the invention is a very fast and easy way to control the dosage of the functional additive itself in the dry mortar mix.

1. Powder mixture suitable for hydrophobizing and thickening cementitious mortars, comprising
a) 5-90 wt % of one or more water-thickeners i), said thickener i) being in powder form and selected from the group of starch, starch ether, poly(meth)acrylate, polyurethane, associative thickeners, sulfo-group containing thickeners, cellulose ether and or guar ether, wherein the cellulose ether and the guar ether are modified with alkyl, hydroxyalkyl and/or carboxymethyl groups, wherein the alkyl groups are selected from methyl, ethyl, propyl and/or C₈- to C₃₀- alkyl groups and the hydroxyalkyl groups are selected from hydroxyethyl and/or hydroxypropyl groups,
b) 5-90 wt % of one or more component ii), wherein component ii) is in powder form and comprises
one or more components iia) selected from the group of organosilicon compounds, fatty acids, fatty acid salts, fatty acid derivatives, wherein the organosilicon compound is an alkyl-trialkoxysilane and/or a dialkyldialkoxysilane, the alkyl group being a C₆- to C₁₂- alkyl group and the alkoxy group being a methoxy, ethoxy, propoxy and/or a butoxy group,
optionally one or more components iib) selected from the group of a water-insoluble polymer, water-soluble polymer, carrier and filler, and
optionally one or more components iic), and
c) 0-70 wt % of adjuvants iii), said adjuvants iii) being in powder form, and
wherein thickener i), component ii) and adjuvants iii) are different powders and the added components sum up to 100 wt %, based on the total amount of the powder mixture.

2. Mixture of claim 1, wherein the thickener i) has a Brookfield viscosity of at least 500 mPas, measured at 20° C./ 20 rpm as a 2 wt % aqueous solution having a pH 7 and/or pH 12.

3. Mixture of claim 1 wherein when the thickener i) is a cellulose ether and/or guar ether modified with alkyl and/or hydroxyalkyl groups, the degree of substitution (DS) of alkyl groups is between 0.1 and 2.5, and/or the molecular substitution (MS) of hydroxyalkyl groups is between 0.05 and 5.0.

4. Mixture of claim 1, wherein component ii) comprises 5 wt % to 100 wt % of component iia) and the remainder being component iib) and/or component iic), wherein the sum of components iia), iib) and iic) sum up to 100 wt %, based on the total amount of component ii).

5. Mixture of claim 1, wherein component ii) comprises 0 to 20 wt % of component iic) wherein the sum of components iia), iib) and iic) sum up to 100 wt %, based on the total amount of component ii).

6. Mixture of claim 1, wherein component ii) comprises component iia) and optionally component iib) and/or component iic), wherein
i) component iib) is a carrier and component iia) being adsorbed on said carrier to form a powder, or
ii) component iib) is a water-soluble polymer and component iia) being encapsulated in a water-soluble polymer powder, or
iii) component iia) in powder form having a melting point of 40° C. or above.

7. Mixture of claim 6, wherein the weight ratio of the component iia) to component iib) is between 10 to 90 and 80 to 20.

8. Mixture of claim 1, wherein the mean volumetric particle size, measured according to ISO 13320:2009, of the thickener i) and the component ii) are between 20 μm and 500 μm.

9. Mixture of claim 1, wherein the mean volumetric particle size of the thickener i) differs not more than 10 times from the mean volumetric particle size of the component ii), the mean volumetric particle size being measured according to ISO 13320:2009.

10. Process to make a dry mortar comprising a hydraulic and/or latent hydraulic setting binder and the mixture claim 1, wherein the mixture is made first, followed by mixing it with the binder.

11. Process of claim 10 wherein the dry mortar comprises the mixture in an amount of 0.05 to 10 wt %, based on the total amount of the dry and uncured mortar.

12. Process of claim 10, wherein the dry mortar comprises 6 to 60 wt %, of hydraulic and/or latent hydraulic binder, based on the total amount of solid components of the uncured mortar.

13. Dry mortar obtainable according to the process of claim 10.

14. Process of preparing a coating or composite mortar, thermal insulation mortar, base coat mortar, adhesive mortar, decorative mortar, sealing compound, lime and/or cement plaster, repair mortar, joint adhesive, ceramic tile adhesive, plywood mortar, bonding mortar, cement primer, cementitious coating for concrete, powder coating, parquet adhesive, smoothing compound, troweling compound and/or masonry mortar, the process comprising mixing a dry mortar of claim 13 with water.
